(19) United States
(12) Patent Application Publication
(10) Pub. No.: US 2018/0160720 A1
(43) Pub. Date: Jun. 14, 2018

(54) APPARATUS AND METHOD FOR PRODUCING A THREE-DIMENSIONAL FOOD PRODUCT

(71) Applicant: 3D Systems, Inc., Rock Hill, SC (US)

(72) Inventor: Kyle William VON HASSELN, Los Angeles, CA (US)

(21) Appl. No.: 15/850,721

(22) Filed: Dec. 21, 2017

Related U.S. Application Data
(63) Continuation of application No. 13/196,859, filed on Aug. 2, 2011.

(51) Int. Cl. A23P 30/00; B29C 64/165; B33Y 30/00; B33Y 10/00

(52) U.S. Cl. CPC A23P 30/00; B29C 64/165; A23P 2020/253; B33Y 10/00; B33Y 30/00

(57) ABSTRACT

A freeform fabrication system for the production of an edible three-dimensional food product from digital input data is disclosed. Food products are produced in a layer-by-layer manner without object-specific tooling or human intervention. Color, flavor, texture and/or other characteristics may be independently modulated throughout the food product.

### CROSS REFERENCE TO RELATED APPLICATIONS

This application is a continuation of and claims priority pursuant to 35 U.S.C. § 120 to U.S. patent application Ser. No. 13/196,859, filed on Aug. 2, 2011.

### FEDERALLY SPONSORED RESEARCH

Not Applicable

### SEQUENCE LISTING OR PROGRAM

Not Applicable

### BACKGROUND

### 1. Field

This application relates to the layer-by-layer proto-typing of a three-dimensional (3-D) object from input digital data, specifically the production of an edible food product in this manner.

### BACKGROUND OF THE INVENTION

### 2. Prior Art

### Introduction to LM Technology

The last two decades have witnessed the emergence of a new frontier in manufacturing technology, commonly referred to as solid freeform fabrication (SFF) or layer manufacturing (LM). A LM process typically begins with the representation of a 3-D object using a computer-aided design (CAD) model or other digital data input. These digital geometry data are then converted into machine control and tool path commands that serve to drive and control a part-building tool (e.g., an extrusion head or inkjet-type print head) that forms the object layer by layer. LM processes are capable of producing a freeform object directly from a CAD model without part-specific tooling (mold, template, shaping die, etc.) or human intervention.

LM processes were developed primarily for producing models, molds, dies, and prototype parts for industrial applications. In this capacity, LM manufacturing allows for the relatively inexpensive production of one-off parts or prototypes, and for subsequent revisions and iterations free of additional re-tooling costs and attendant time delays. Further, LM processes are capable of fabricating parts with complex geometry and interiority that could not be practically produced by traditional fabrication approaches such as machining or casting.

Examples of LM techniques include stereo lithography (Sla), selective laser sintering (SLS), laminated object manufacturing (LOM), fused deposition modeling (FDM), laser-assisted welding or cladding, shape deposition modeling (SDM), and 3-D printing (3-DP). The latter category includes extrusion and binder deposition technologies.

### Applicability of LM Technology to Food Production

There are several inherent limitations associated with many of the LM processes mentioned above in regards to their potential application to food production. To begin with, the majority of these processes require the utilization of expensive, difficult to handle and/or dangerous materials that are, without exception, non-edible or toxic. Many LM techniques, including those involving metallic, ceramic, and glass materials require such high temperatures that they necessitate expensive, high-tech heat generation apparatus such as induction generators and lasers. Even processes utilizing thermo-plastics require moderately high temperatures (140° to 380° C.) in order to maintain a workable low-viscosity material state. Further, LM processes often involve complex and expensive post-processing equipment that itself may involve toxic materials.

Clearly, prior-art techniques such as these are too toxic and/or thermally extreme to be used to fabricate edible food products. Additionally, these methods would lack the ability to adequately vary color and flavor independently throughout the 3-D food product.

### Limitations of Extruding Food Products

While most LM processes are unsatisfactory for food applications, as discussed above, 3-D printing, including extrusion printing and binder deposition printing, does have potential for such applications. Extrusion 3-D printing has been applied to food production in a preliminary manner, restricted to the automated extrusion of viscous food-paste for building relatively simple food objects. For example, U.S. Pat. No. 6,280,784 (Aug. 28, 2001), and U.S. Pat. No. 6,280,785 (Aug. 28, 2001), issued to Yang et al., describe the extrusion of tubular food material onto a platform automated with sliced CAD data to build 3-D food products in a layer-by-layer manner.

Extrusion printing processes, such as those described by Yang et. al. are fundamentally limited, since they utilize semi-solid food materials that are inherently resigned to warping. Extrusion technologies are additionally limited by their support material strategy. In order to support the product during the build process, these methods require the extrusion of additional structural members, in excess of the product geometry. This support material must be manually removed during post-processing and is non-recyclable. The subsequent removal of extruded support material can be time consuming, can require use of force that compromises the integrity of the printed part, and can leave a rough finish upon the part at attachment points. Further, the necessity of printing additional support material slows printing and raises material costs.

The prior art precedents are additionally limited with respect to the production of a food product because they/rely upon the expulsion of a continuous tubular food material, that limits their capacity to modulate characteristics of the food material within a given food product. It would, for example, be impossible to precisely control the placement of color, flavor or other food variables, since they would blend together during transition from one stock food material to another. This imprecision in color modulation precludes the generation of complex patterns, images, or text upon the surfaces or within the interior of the food object.

### Advantages of Binder Deposition Printing

This invention is related to a class of 3-D printing systems that utilize translating powder bins and ink-jet binder solution dispensers. This type of technology offers significant advantages over extrusion printing in general, not just with respect to food applications. U.S. Pat. No. 5,340,656, issued to Sachs et al. (Aug. 23, 1993), describes such a system. A powder-like material (e.g., powdered ceramic, metal, or plastic) is deposited in sequential layers, each on top of the previous layer. Following the deposition of each layer of powdered material, a liquid binder solution is selectively applied, using an ink-jet printing technique or the like, to appropriate regions of the layer of powdered material in accordance with a sliced CAD model of the three-dimensional part being formed. This binder application fuses the current cross-section of the part to previously bound cross-sections, and sub-sequent sequential application of powder layers and binder solution complete the formation of the desired part.

A printed part is, in this manner, supported at all times during the build process by submersion in surrounding unbound material, which reduces part shifting and facilitates the production of intricate and delicate geometries. Further-more, unbound powder can be easily removed and recycled for further use, increasing temporal and monetary efficiency. Fused deposition 3-D printing therefore provides for greater precision and range in the construction of a 3-D object than does extrusion, and is more rapid and cost-effective.

While extrusion 3-D printing offers only limited capacity for color variation, as discussed above, binder deposition 3-D printing is able to precisely modulate color within a printed object. U.S. Pat. No. 6,799,959, issued to Tochimoto et al. (Oct. 5, 2004), describes a method for varying color throughout a 3-D object using a plurality of colored binders.

Further advancements in binder deposition 3-D printing are described in additional prior art references. Improvements in the chemical composition of powder mixtures and binder solutions that reduce bound material shrink-age and expansion relative to unbound powder, stock powder bins that communicate with build powder bins to increase efficiency in the transfer of powder mixture from the former to the latter, and the incorporation of conventional ink-jet printer components that are lighter and less expensive are described in U.S. Pat. No. 7,120,512 (Oct. 10, 2006, Kramer et al.), U.S. Pat. No. 7,296,990 (Nov. 20, 2007, Devos et al.), U.S. Pat. No. 7,389,072 (Oct. 14, 2008, Collins et al.), respectively. Additionally, methods for the reduction of powder settling or migration during the printing process, and wetting techniques that reduce unbound powder migration during the printing process are described in U.S. Pat. No. 7,389,154 (Jun. 17, 2008), issued to Hunter et al.

Although binder deposition 3-D printing is faster, less expensive, more precise and allows for more complex geometries than does tubular extrusion, there is no precedent for applying the technique to food production. In fact, binder deposition 3-D printing, as described in the patented prior art, is clearly not applicable to food applications, since it utilizes the use of inedible and/or toxic materials.

### Limitations of Unpatented Prior-Art

Several examples of unpatented prior art concerning 3-D printing with potentially edible materials exist. The Solheim Additive Manufacturing Lab at the University of Washington, for example, commonly substitutes a variety of inexpensive materials (e.g. sugar, salt, bone powder, cement products, plaster, glass, porcelain, ceramic, stoneware and terracotta) for proprietary powder mixtures, in order to lessen the operational cost of educational printing applications. Although some of these ingredients are edible, they are used in combination with additional toxic ingredients, thereby yielding an inoperable (inedible) 3-D object. For example, industry standard inkjet cartridges such as HP C4800a may be manufactured from toxic materials, and their ink contains chemicals that may cause irritation of the skin, eyes and lungs. If ingested, these chemicals may induce nausea, vomiting and diarrhea. Chronic health effects may include cancer.

The CandyFab Project, another unpatented prior art, has developed the ‘CandyFab 6000’, a LM machine that goes further toward the production of entirely edible 3-D food objects. CandyFab 6000 employs an automated heating element that passes over a sugar substrate to fuse the current layer to previous layers, creating a partially caramelized 3-D sugar object. This method requires manual deposition of layer material, and results in crude lamination and coarse resolution. The CandyFab 6000 is incapable of producing an intricate, detailed edible food object, and it is incapable of varying color, flavor or texture.

No prior art, patented or otherwise, describes a binder deposition 3-D printing system for the production of edible food products. There is no precedent for the application of flavor to a freeform fabrication product. Further, no prior art adequately provides for the independent application of multiple colors, flavors and/or textures to a freeform fabrication product, let alone to a printed food product. In fact, neither a digital means for initially describing these variables independently of one another, nor a mechanical means of instituting such variation, nor a method of operating such technology currently exists.

Since the color, flavor/scent, and texture of a 3-D food object are important to the experience of the eater, it follows that the ability to adequately and independently control these variables is equally important in the production of a fully developed and satisfactory printed food-product. Our application describes a 3-D food production system that does meet these criteria, using entirely edible food-material mixtures and binder solutions to produce a food-product with independently varying color, flavor, and texture.

### SUMMARY

This system involves the freeform fabrication of a food object in a layer manufacturing manner without object specific tooling or human intervention. In accordance with one embodiment, edible food material(s) are distributed layer by layer, and edible binder is selectively ejected upon each successive layer, according to CAD data for the product being formed. Selected regions of the current cross-section are thus fused to previously fused cross-sections. Unbound food material(s) act to support the food product during the fabrication process, allowing for the generation of delicate and intricate food products. Selective color, flavor, and/or texture may be independently modulated throughout the body of the 3-D food object.

### BRIEF DESCRIPTION

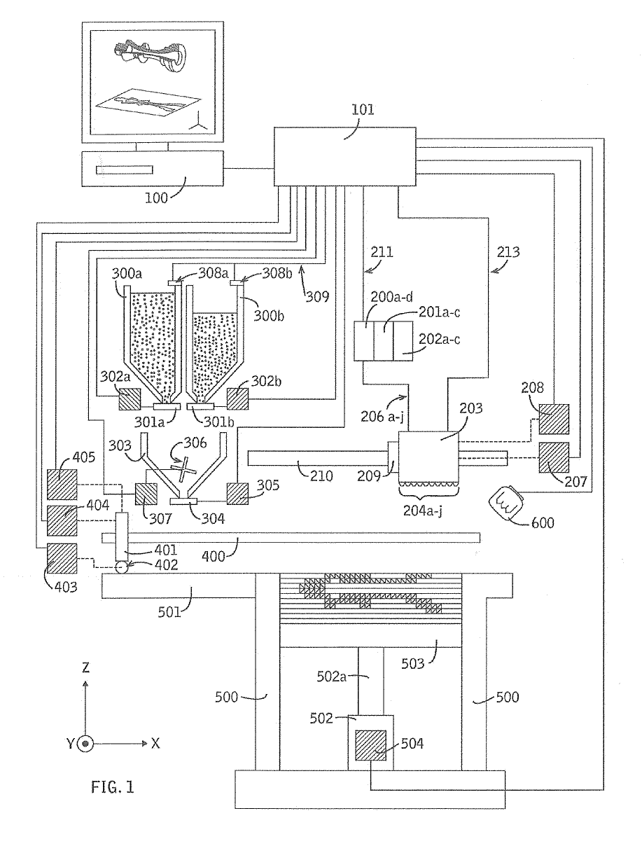

FIG. 1. Schematic in accordance with one embodiment of the layer manufacturing system for food fabrication showing the printing apparatus, food material supplying apparatus, food material distributing apparatus and food product forming apparatus.

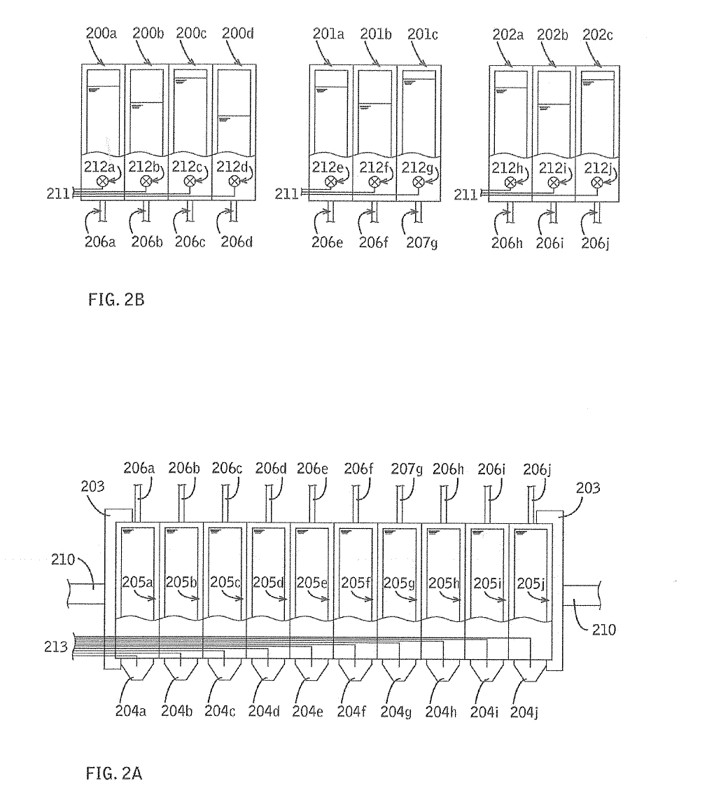

FIG. 2A. Schematic in accordance with one embodiment of the printing apparatus showing the storage, ejector and cartridge parts for edible binder, for flavorant and for colorant.

FIG. 2B. Schematic in accordance with one embodiment of the printing apparatus showing the storage, ejector and cartridge parts for edible binder, for flavorant and for colorant.

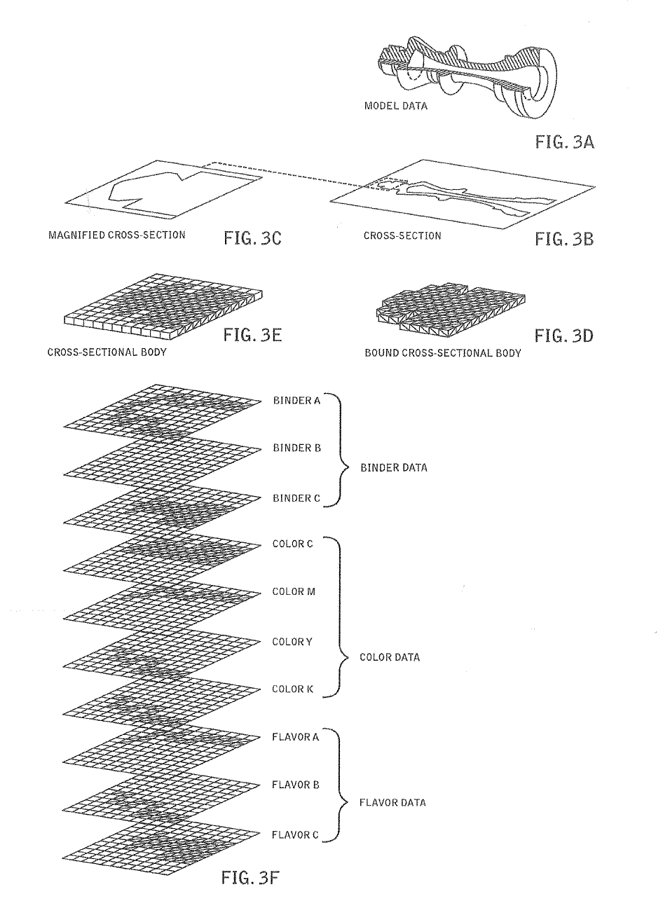

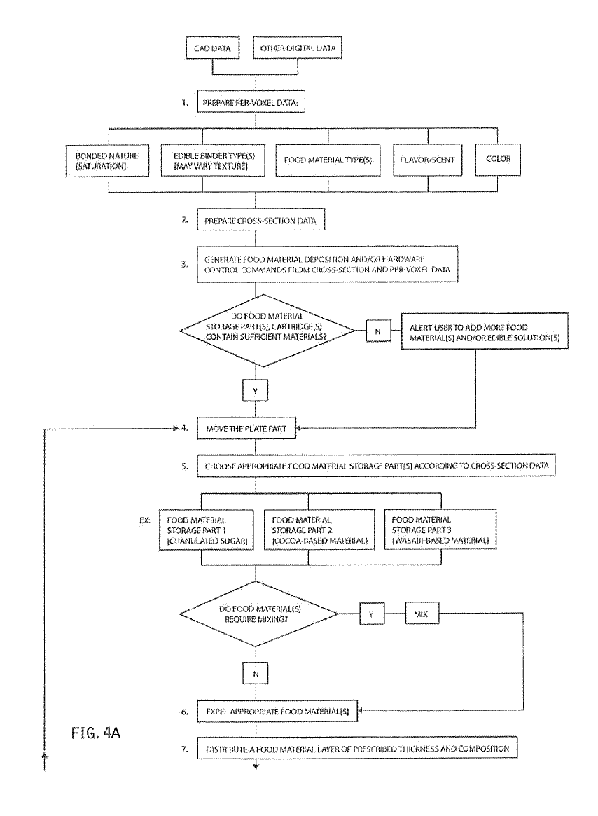

FIG. 3A. Schematic in accordance with one embodiment of the fabrication of an example 3-D food product, showing example model data and derived cross-sectional pro-files including per-voxel data with respect to bonded nature, color, flavor, edible binder type, and food material type.

FIG. 3B. Schematic in accordance with one embodiment of the fabrication of an example 3-D food product, showing example model data and derived cross-sectional pro-files including per-voxel data with respect to bonded nature, color, flavor, edible binder type, and food material type.

FIG. 3C. Schematic in accordance with one embodiment of the fabrication of an example 3-D food product, showing example model data and derived cross-sectional pro-files including per-voxel data with respect to bonded nature, color, flavor, edible binder type, and food material type.

FIG. 3D. Schematic in accordance with one embodiment of the fabrication of an example 3-D food product, showing example model data and derived cross-sectional pro-files including per-voxel data with respect to bonded nature, color, flavor, edible binder type, and food material type.

FIG. 3E. Schematic in accordance with one embodiment of the fabrication of an example 3-D food product, showing example model data and derived cross-sectional pro-files including per-voxel data with respect to bonded nature, color, flavor, edible binder type, and food material type.

FIG. 3F. Schematic in accordance with one embodiment of the fabrication of an example 3-D food product, showing example model data and derived cross-sectional pro-files including per-voxel data with respect to bonded nature, color, flavor, edible binder type, and food material type.

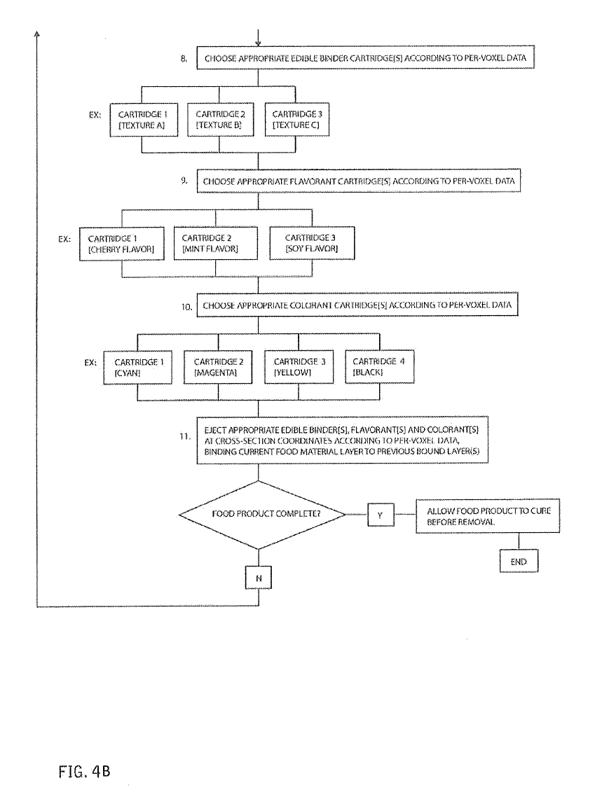

FIG. 4A. Flow chart in accordance with one embodiment of the layer manufacturing system for food fabrication, showing the sequence of steps and decisions involved in the fabrication process.

FIG. 4B. Flow chart in accordance with one embodiment of the layer manufacturing system for food fabrication, showing the sequence of steps and decisions involved in the fabrication process.

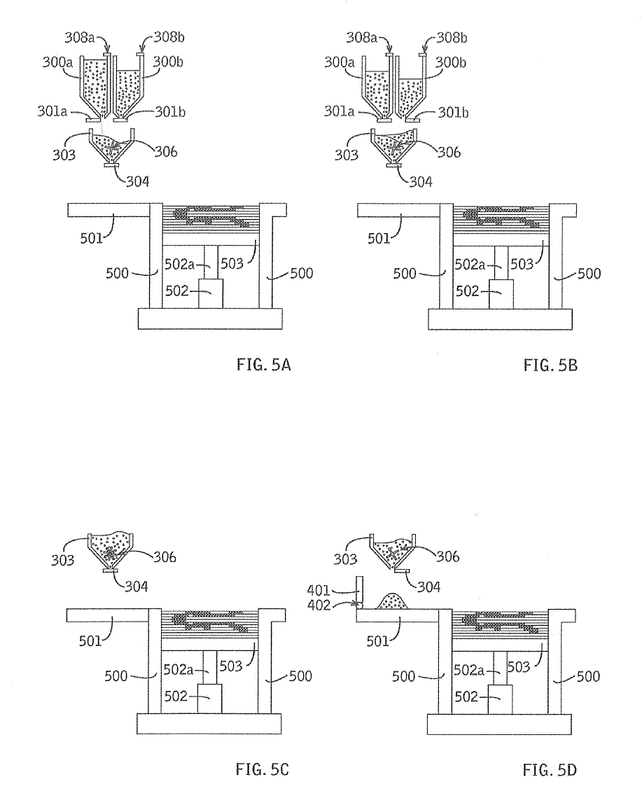

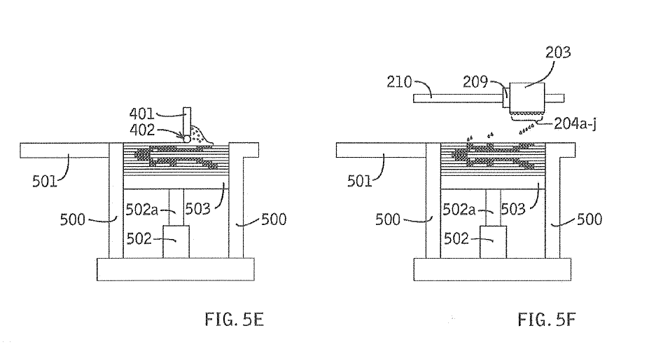

FIG. 5A. Schematic in accordance with one embodiment, showing the layer-by-layer fabrication of an example 3-D food product wherein food material mixing may occur prior to food material distribution and edible binder deposition.

FIG. 5B. Schematic in accordance with one embodiment, showing the layer-by-layer fabrication of an example 3-D food product wherein food material mixing may occur prior to food material distribution and edible binder deposition.

FIG. 5C. Schematic in accordance with one embodiment, showing the layer-by-layer fabrication of an example 3-D food product wherein food material mixing may occur prior to food material distribution and edible binder deposition.

FIG. 5D. Schematic in accordance with one embodiment, showing the layer-by-layer fabrication of an example 3-D food product wherein food material mixing may occur prior to food material distribution and edible binder deposition.

FIG. 5E. Schematic in accordance with one embodiment, showing the layer-by-layer fabrication of an example 3-D food product wherein food material mixing may occur prior to food material distribution and edible binder deposition.

FIG. 5F. Schematic in accordance with one embodiment, showing the layer-by-layer fabrication of an example 3-D food product wherein food material mixing may occur prior to food material distribution and edible binder deposition.

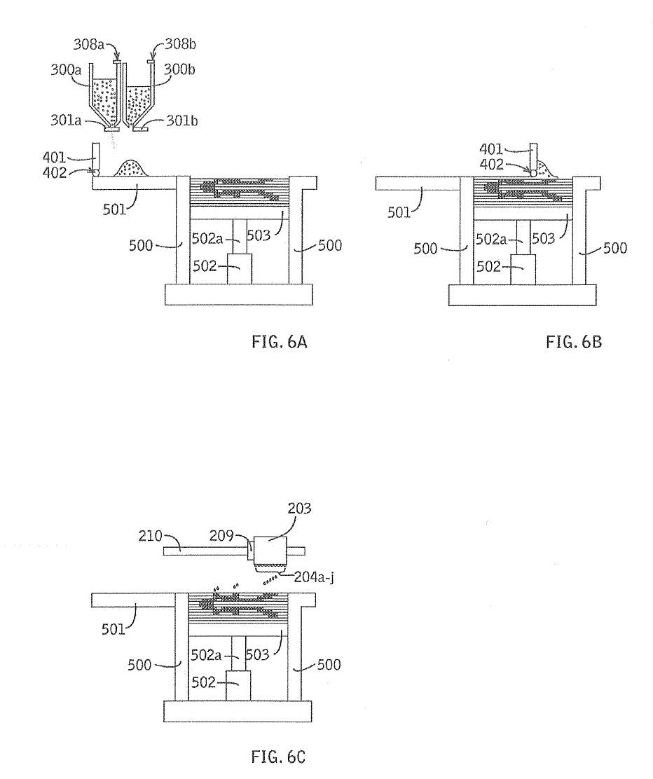

FIG. 6A. Schematic in accordance with one embodiment, showing the layer-by-layer fabrication of an example 3-D food product wherein no food material mixing occurs during the fabrication process.

FIG. 6B. Schematic in accordance with one embodiment, showing the layer-by-layer fabrication of an example 3-D food product wherein no food material mixing occurs during the fabrication process.

FIG. 6C. Schematic in accordance with one embodiment, showing the layer-by-layer fabrication of an example 3-D food product wherein no food material mixing occurs during the fabrication process.

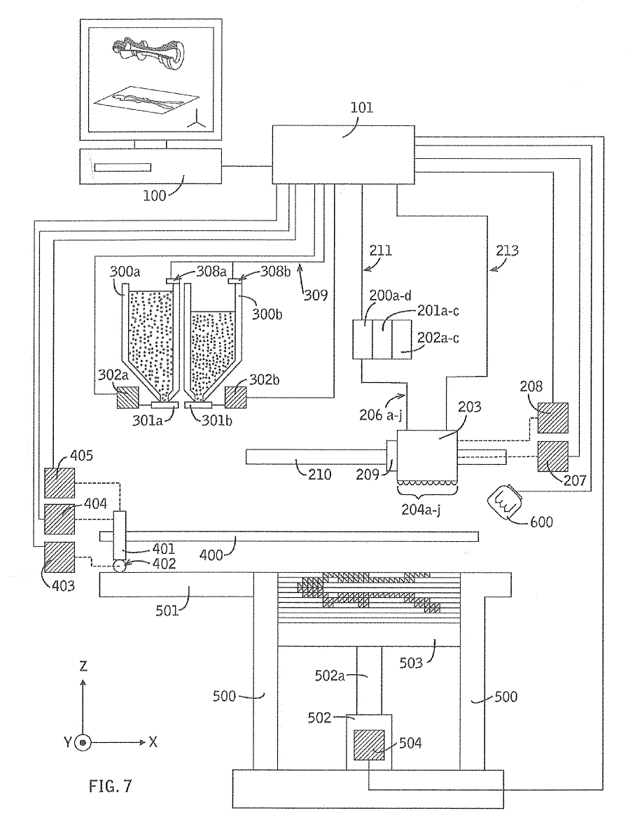

FIG. 7. Schematic in accordance with one embodiment of the layer manufacturing system for food fabrication showing the 3-D food product forming apparatus, wherein the food material supplying apparatus lacks a mixing apparatus.

### DETAILED DESCRIPTION

### Detail of 3-D Food Assembly Components

FIG. 1 is a schematic overview of a LM system for the production of a 3-D food product, in accordance with one embodiment.

The system comprises a computer 100 and a 3-D food product forming apparatus. The computer 100 is a general desktop type computer or the like that is constructed to include a CPU, RAM, and others. The computer 100 is electronically connected to controlling part 101.

The 3-D food product forming apparatus comprises a controlling part 101, a printing apparatus 200-213, a food material supplying apparatus 300-309, a food material distributing apparatus 400-405, a food product forming apparatus 500-504 and a curing part 600. Each of these parts is electrically connected to the controlling part 101.

### The Printing Apparatus

The printing apparatus 200-213 includes a driving part 207 for moving the carriage part 203 along the Y-direction guiding part 209, and a driving part 208 for moving said carriage part 203 along the X-direction guiding part 210. Together these parts 207-210 allow the carriage part 203 to move in a plane defined by the X-axis and the Y-axis, as dictated by the controlling part 101, such that it may reach any location within said plane (FIG. 1).

The carriage part 203 contains colorant ejector parts 204a-d, connected to colorant cartridge parts 205a-d, each of which contains edible colorant. The colorant cartridge parts 205a-d are connected by hose parts 206a-d to the colorant storage parts 200a-d, that may contain surplus colorant (FIG. 2A-B).

The carriage part 203 additionally contains edible binder ejector parts 204e-g, connected to edible binder cartridge parts 205e-g, each of which contains edible binder. The edible binder cartridge parts 205e-g are connected by hose parts 206e-g to the edible binder storage parts 201a-c, which may contain surplus edible binder.

The carriage part 203 further contains flavorant ejector parts 204h-j, connected to flavorant cartridge parts 205h-j, each of which contains edible flavorant. The flavorant cartridge parts 205h-j are connected by hose parts 206h-j to the flavorant storage parts 202a-c, which may contain surplus flavorant.

Each of the colorant, edible binder and flavorant ejector parts 204a-j is connected to the controller 101 by an ejector connecting part 213. Each of the colorant storage parts 200a-d, edible binder storage parts 201a-c, and flavorant storage parts 202a-c contains a sensor part 212a-j that is connected to the controlling part 101 by a sensor connecting part 211.

The cartridge parts 205a-j and their associated ejector parts 204a-j are components of the carriage part 203, and are therefore freely movable in the XY-plane. The independent ejection behavior of each of the ejector parts 204a-j is individually controlled by the controlling part 101. Solutions ejected from the ejector parts 204a-j adhere to the specified region(s) of the current printing stratum (FIG. 1).

While this embodiment contains four colorants, three edible binders, and three flavorants, yielding 10 sets of associated ejection, storage and regulatory components (200a-c, 201a-c, 202a-c, 204a-j, 205a-j, 206a-j, 211, 212a-j, 213), other embodiments may include any number of colorants, edible binders and/or flavorants, which would modify the number of sets of associated components in kind (FIG. 2A-B).

### Food Material Supplying Apparatus

The food material supplying apparatus 300-309 includes one or more food material storage parts 300a-b that store food material(s). Although two are depicted, there may be any number of food material storage parts 300. The food material(s) stored within these food material storage parts 300 serve as the printing substrate that receive ejected colorant, edible binder, and flavorant solutions (FIG. 1).

Sensor parts 308a-b are connected to the controlling part 101 by a sensor connecting part 309. The sensor parts 308a-b convey the quantity of remaining food material contained in each food material storage part 300 to the controlling part 101.

The shutting parts 301a-b are operated by driving parts 302a-b that are electrically connected to the controlling part 101.

The mixing area part 303 contains a mixing part 306 that is operated by a driving part 307, which is electrically connected to the controlling part 101. A shutting part 304 is operated by a driving part 305 that is electrically connected to the controlling part 101.

### Food Material Distributing Apparatus

The food material distributing apparatus 400-405 includes a distributing part 402 that has a Y-direction dimension at least as great as the Y-direction dimension of the food product containing part 500. The distributing part 402 is attached to a holding part 401 and an associated guiding part 400 that is oriented along the X-axis (FIG. 1).

The X-direction driving part 404 and the Z-direction driving part 405 drive the holding part 401 along the X- and Z-axes, respectively. The holding part 401 is connected to the distributing part 402, which is driven by a driving part 403. Driving parts 403, 404 and 405 are electrically connected to the controlling part 101.

### Food Product Forming Apparatus

The food product forming apparatus 500-504 comprises a food product containing part 500, a food material holding part 501, a Z-direction moving part 502, a driving part 504 and a plate part 503 (FIG. 1).

The food material holding part 501 is attached to the food product containing part 500, which exhibits a rectangular profile in a XY-cross-section and is characterized by a recessed center. The plate part 503 is located within the recessed center of the food product containing part 500, and the side surfaces of the former are in contact with the vertical inner wall of the latter. The plate part 503 is attached to a supporting part 502a that is driven along the Z-axis by a Z-direction moving part 502. The Z-direction moving part 502 is operated by a driving part 504 that is electrically connected to the controlling part 101. The three-dimensional space that is defined by the plate part 503 and the vertical inner walls of the food product containing part 500 constitutes the area for forming a 3-D food product.

A curing part 600 is electronically connected to the controlling part 101 and may emit light, ultraviolet light, heat, or other similar curing energy.

### Operation of Invention Operational Process

FIG. 4 is a flowchart describing the overall operation of the food product freeform fabrication system, in accordance with one embodiment. The specific operation of the food material supplying apparatus 300-309 and of the printing apparatus 200-213, as outlined below, will be described in further detail in sub-sections to follow.

### Calculating Per-Voxel Data

To begin the operation of this embodiment, computer-aided design (CAD) data or other digital data describing a 3-D food product are transferred to the computer 100. These data may include, but are not limited to, drawings, images, scans and geometric representations. These data further define all desired characteristics of each individual voxel (the smallest addressable region of a given 3-D space) of the 3-D food product, including, but not limited to, bonded nature (saturation), edible binder type (that may act to vary texture), food material type (that may act to vary texture, flavor, color or other variables), flavor/scent and color (FIG. 4 step 1). Any or all of these characteristics may apply to the exterior surface condition of the food product, the interior of the food product, or both, and each characteristic is designated independently on a per-voxel basis.

Prior art either ignores variable texture, flavor and color, or assumes that the characteristics involved are always coincident. This is a limitation of the prior art, since a 3-D food product designer may require, for example, that some red regions of a given food product are cherry-flavored, while other red regions are mint-flavored.

### Calculating Cross-Section Data

A series of sequential cross-sectional profiles for the food product are generated by the computer 100, using software that slices the CAD geometry into thin cross-section bodies of many parallel layers (FIG. 4 step 2). The number of layers required for the construction of the food product, and the thickness of each layer may vary with food material and desired product resolution.

This slicing of CAD geometry and its associated per-voxel data is illustrated in FIG. 3, using an example food product digital model. CAD data for the example food product (FIG. 3A) are sliced into constituent cross-sections, one of which is shown in FIG. 3B. A region of this example cross-section is magnified in FIG. 3C in order to illustrate voxel-scale detail. The resultant food material layer represented by the magnified cross-sectional region is shown in FIG. 3E, with individual voxels delineated. FIG. 3D shows the bound portion of said food material layer. FIG. 3F illustrates potential characteristics defined by the cross-sectioned per-voxel data, including, but not limited to, bound nature, binder type, color and flavor.

Based upon these cross-sectioned per-voxel data, the computer 100 generates sequential commands that are transmitted to the controlling part 101 that will control the movements and actions of the 3-D food product forming apparatus in order to build the desired food product (FIG. 4, step 3). The controlling part 101 further communicates with the computer 100 and with the 3-D food-product forming apparatus 500-504 to monitor food material, edible binder, colorant and flavorant quantities, in order to alert the user in the event that insufficient materials exist to complete a build.

### Modulating Food Material Among Cross-Sections

As directed by the controlling part 101, the driving part 504 drives the Z-direction moving part 502 that, in turn, moves the supporting part 502a and the attached the plate part 503 along the Z-axis. The plate part 503 is therefore able to occupy any position along the z-axis within the recessed center of the food product containing part 500, allowing it to be positioned appropriately to receive the first, or next, layer of food material (FIG. 4, step 4).

According to some embodiments, several food material storage parts 300a-b containing different food materials may exist. These food materials may vary in flavor, color, texture or other characteristics. They may consist of a single ingredient (for example, granulated sugar or cocoa), or they may comprise a pre-mixed combination of multiple ingredients (for example, a food mixture containing flour, salt, and powdered egg product).

In step 5 of FIG. 4, cross-section data for the current cross-sectional profile of the 3-D food product are used to select the appropriate food material storage part(s) 300a-b. For example, the food product may be comprised of multiple layers of granulated sugar, multiple layers of cocoa and multiple layers consisting of both granulated sugar and cocoa. In step 5, the composition of the current cross-section is determined, and either the food material storage part 300a containing granulated sugar or the food material storage part 300b containing cocoa, or both, are selected, as appropriate. If the current cross-section requires plural food materials to be combined, said food materials may need to be transferred to the mixing area part 303 for mixing by the mixing part 306 before proceeding to step 6. In step 6 of FIG. 4, the appropriate food material(s) or food material mixture(s) are expelled onto the food material holding part 501.

A layer of the appropriate food material is optimally distributed by the distributing part 402 upon the plate part 503, in a layer of the prescribed thickness (FIG. 4, step 7).

Modulating Edible Binder, Color and Flavor within a Cross-Section

In accordance with some embodiments, while food material type varies by cross-section, food solution (edible binder, colorant and/or flavorant) type may vary by voxel throughout a single cross-section. Within a single ‘cocoa food material’ layer, therefore, there may be areas (one or more voxels) that are, for example, cherry flavored and red, areas that are cherry flavored and blue, areas that are mint flavored and yellow, and areas that are soy flavored with no added color. Texture and/or other characteristics may also vary independently within a single cross-section.

The carriage part 203 may include plural edible binder cartridge parts 205e-g, each containing a different edible binder. These edible binders may vary in resultant texture or in other characteristics. In step 8 of FIG. 4, per-voxel data for the current cross-section are used to select the appropriate edible binder cartridge part 205e-g. Additional characteristics of each voxel, such as flavor/scent and color, may be modulated by further selecting cartridge parts 205a-d,h-j that will selectively apply colorant and flavorant to the current food material layer. In steps 9 and 10 of FIG. 4, per-voxel data for the current cross-section are used to select the appropriate flavorant cartridge(s) and colorant cartridge (s), respectively. Additional steps may be required to modulate other food characteristics.

The uncoupled variation of edible binder, colorant and flavorant deposition allows for independent variation of texture, color and flavor throughout the food product. There is no precedent in the prior art for adequate independent variation of multiple characteristics within a single product.

### Binding the Food Product Layer-by-Layer

Once the appropriate edible binder, colorant and flavorant cartridge parts 205a-j have been selected, based upon the prescribed per-voxel characteristics (steps 8-10 of FIG. 4), application of these solutions to the food material layer formed in step 6 of FIG. 4 occurs. In step 11 of FIG. 4, the appropriate edible binder(s), colorant(s) and flavorant(s) are ejected upon the food material layer by ejector parts 204a-j, at cross-section coordinates dictated by the per-voxel CAD data. Subsequent to ejection of edible solutions, the curing part 600 may apply thermal energy to the current food material layer in order to cure the bound regions and stabilize the food product as a whole. The current layer, representing one cross-sectional body of the entire product, is in this manner selectively fused to previously fused layers to construct a 3-D food product with independently variable food characteristics.

### Operation of Food Material Supply and Distribution Apparatus

The specific operation of the food material supplying and distributing apparatus 300-309, 400-405, is herein discussed in greater detail, as shown in FIG. 1, FIG. 5A-F and FIG. 6A-C.

In accordance with one embodiment, the controlling part 101 controls the food material supplying apparatus 300-309 and the food material distributing apparatus 400-405, as dictated by cross-section and per-voxel data-based commands generated by the computer 100. These apparatus 300-309 and 400-405, along with the food product forming apparatus 500-504, perform the food material-related portions of the fabrication of the 3-D food product by selecting, mixing, distributing and containing said food materials in the manner detailed below (FIG. 1).

### Selecting Food Material(s)

The controlling part 101 dictates the selection of the appropriate food material(s) for each food material layer within a 3-D food product. Each of these layers may be composed of a single food material (that may itself be a single ingredient or a mixture of more than one ingredient), or a mixture of several food materials combined in a predefined ratio. Further, each of these layers may differ compositionally from neighboring layers, or many sequential layers may exist with identical food material composition. For example, while layers 1 through 19 of a 3-D food product containing a total of 850 layers may be composed solely of granulated sugar, layer 20 of 850 may require a food material mixture containing sugar, flour, salt, and powdered egg product in a predetermined ratio.

The controlling part 101 selects the food material storage part or parts 300a-b necessary to compose each individual layer in turn, and controls the volume of each food material or materials dispensed from each food material storage part(s) 300a-b. Each food material storage part 300a-b contains a sensor part 308a-b, which is also connected to the controlling part 101 via a sensor connecting part 309. To prevent process disruption, the sensor part 308a-b allows the controlling part 101 to monitor the volume of food material contained within each food material storage part 300a-b in order to ensure sufficient quantities exist for a given build (FIG. 1).

### Mixing Food Material(s)

Once the volume of food material(s) has been verified, and the appropriate food material(s) have been selected for a given layer, the food material storage part (or the first of multiple parts) 300a is moved into position, if necessary. The shutting part 301a of the food material storage part 300a is then opened and subsequently closed by the driving part 302a, permitting the transfer of a predetermined volume of the ingredient or mixture therein, for example, granulated sugar, to the mixing area part 303. The food material storage part 300a is then returned to its default position (FIG. 5A).

If the given food material layer requires the involvement of multiple food material storage parts 300a-b, that is, if it comprises a combination of multiple food materials, the next required food material storage part 300b is positioned in order to expel further ingredients. The shutting part 301b of the food material storage part 300b is opened by the driving part 302b, and a predetermined volume of the ingredient or mixture therein, for example, powdered egg product, or a food mixture containing flour, salt, and powdered egg product, is transferred to the mixing area part 303 (FIG. 5B).

Once all food material storage part(s) 300a-b required for the composition of a given layer have been sequentially moved into position, have expelled the appropriate volume of their respective ingredients into the mixing area part 303, and have been moved back into their default positions, the controlling part 101 commands the driver part 307 to drive the mixing part 306 for a length of time and in a manner sufficient to mix the food materials optimally (FIG. 5C). When mixing is complete, the shutting part 304 of the mixing area part 303 is opened and subsequently closed by the driving part 305. This permits the transfer of the mixed food material to the food material holding part 501 (FIG. 5D).

In the event that a given food material layer contains only a single food material, the controlling part 101 may omit the above mixing protocol (FIG. 6A-C).

### Distributing Food Material(s)

The plate part 503 is prepared for receipt of the food material by the driving part 504, the supporting part 502a and the Z-direction moving part 502 as described previously, in order to lower the position of the plate part 503 within the food product containing part 500 by the desired depth of the current food material layer (FIG. 5A).

The food material or food material mixture is transferred from the food material holding part 501 to the plate part 503 by the distributing part 402 and its associated parts 400, 401, 403, 404, as dictated by commands from the controlling part 101 based on the type and composition of the food material(s) involved and requisite layer thickness. The distributing part 402 and the holding part 401 are moved along the guiding part 400 by the driving part 404. Simultaneously, the distributing part 402 is rotated about its Y-axis by the driving part 403. Together these operations optimally distribute the food material or food material mixture upon the plate part 503. The driving part 405 may additionally provide for vertical movement of the holding part 401 in coordination with the horizontal movements of the distributing part 402 in order to optimally distribute the food material (FIG. 5E).

The resultant food material layer on the plate part 503 constitutes the current, as yet unbound, cross-section of the food product being fabricated and is ready for receipt of edible solutions from components of the carriage part 203 that will selectively bind the appropriate voxels of the current layer (FIG. 5F). Sequential selective binding of subsequent food material layers completes the formation of the desired food product in a layer-by-layer fashion.

### Advantages Over Prior Art

The embodiment described above distinguishes itself from the prior art in its capacity for varying layer com-position. In accordance with this embodiment, one or more food material storage parts 300a-b may contain single ingredients, such as a specific type of sugar or flour. Such a single ingredient may be the sole constituent of a printing stratum, or it may be mixed with one or more additional single ingredients from other food material bin(s), in a predetermined ratio, to produce a food material mixture for use as a printing stratum. Additionally, one or more food material storage parts 300a-b may contain a manually premixed food material mixture, such as a mixture of flour, salt, and powdered egg product. Such a manually premixed food material mixture may be the sole constituent of a printing stratum, or it may be mixed with one or more additional single ingredients, or with one or more additional premixed food mixtures from other food material storage parts 300a-b, in a predetermined ratio, to produce a food material mixture for use as a printing stratum.

Prior art does not adequately address the use of multiple stock materials, nor the automated mixture of said materials, because the rapid prototyping of industrial 3-D objects generally involves a single material, or very few materials that are precisely engineered. However, the utility of a food product depends upon a wider scope of sensory involvement than does that of an industrial object. Variation of food composition (for example, flour vs. sugar), food texture (for example, crunchy vs. chewy), flavor (for example, cherry vs. mint) and other characteristics allows for unique eating experiences among food products, or within a single food product. It is therefore vital for a 3-D food product fabrication system to be capable of such variation.

In a culinary setting it may be convenient to supply food material bins with single ingredients, and to control the proportions of their subsequent mixture via the computer 100. However, at times it may be efficient to manually pre-mix certain food material combinations when food compositions comprising a multitude of ingredients are desired, or when a given mixture is commonly used. Both scenarios are accommodated by the embodiment described above. This flexibility and capability for variation represents an advancement over the prior art, which tends to value a single engineered, pre-mixed substrate, rather than the researched or impromptu discovery of unique food mixtures (recipes) that is a trade-mark of culinary applications.

### Operation of Carriage Components

Once a food material layer has been distributed upon the plate part 503, as shown in FIG. 5E, this as yet unbound layer is ready for receipt of edible solutions ejected from the various ejector parts of the carriage part 203. The specific operation of the carriage components, to this end, is herein discussed in greater detail.

### Movement of Carriage Components

In accordance with one embodiment, cross-section and per-voxel data are transmitted from the computer 100 to the controlling part 101, which controls the motion of the carriage part 203 via the Y-direction guiding part 209, the X-direction guiding part 210 and the associated driving parts 207 and 208, respectively (FIG. 1): The carriage part 203 is thus driven to the appropriate (bound voxel) cross-section coordinates for the deposition of edible solutions.

### Management of Edible Solutions

The controlling part 101 further informs the actions of the carriage sub-components, which include colorant cartridge parts 205a-d, edible binder cartridge parts 205e-g, flavorant cartridge parts 205h-j and their associated ejector parts 204a-d, 204e-g and 204h-j, respectively. While each cartridge part 205a-j may contain a quantity of its respective edible solution, surplus colorant, edible binder and flavorant may be stored additionally in the associated storage parts 200a-d, 201a-c and 202a-c, respectively. These surplus solutions may be transferred as necessary from the storage part to the cartridge part 205a-j via the associated hose part 206a-j. Each storage part 200a-d, 201a-c and 202a-c additionally contains a sensor part 212a-j that is connected to the controlling part 101 via a sensor connecting part 211. The sensor part 212a-j allows the controlling part 101 to monitor the volume of edible solution contained within each storage part 200a-d, 201a-c and 202a-c in order to ensure sufficient quantities exist for a given build (FIG. 2A-B).

### Ejection of Edible Solutions

The cartridge parts 205a-j and ejector parts 204a-j provide for the ejection of the appropriate colorant(s), edible binder(s) and/or flavorant(s) at the appropriate cross-section coordinates of a given food material layer. Each ejector part 204a-j is connected to the controlling part 101 via an associated ejector connecting part 213 that allows the controlling part 101 to independently control each ejector. Edible binder (s), colorant(s) and/or flavorant(s) may be ejected simultaneously by their respective ejector parts 204a-j upon a given voxel of food material, or they may be ejected sequentially. Alternately, these solutions may be mixed prior to ejection.

The saturation of a given food material voxel may also be controlled by the controlling part 101, according to per-voxel data for bound nature. Variable saturation of food material may be achieved through the application of a greater or lesser volume of edible solution(s). Greater saturation may alternately be achieved through multiple sequential solution applications.

Thus the controlling part 101 dictates which regions of a given food product cross-section are bound, and which are colored, flavored, and/or variably textured, according to cross-section and per-voxel data for desired food product characteristics.

### Varying Texture Independently

In accordance with this embodiment, the carriage part 203 may contain plural edible binder cartridge parts 205e-g, each of which may contain a unique edible binder. Edible binder type may influence the resultant texture of the bound food product. Edible binder(s) are ejected from the cartridge parts 205e-g upon selected voxels of a food material layer via the ejector part(s) 204e-g (FIG. 2A-B). This allows for the production of multiple food textures within a given 3-D food product. For example, consider a food material mixture containing sugar, flour, and powdered egg product. It may produce a granular, ‘candy-like’ texture when combined with an edible solution of distilled water, alcohol, vegetable glycerin and salt. Alternatively, it may produce a smooth, ‘frosting-like’ texture when combined with an edible solution of milk, alcohol and sugar. Intermediate or unique textures may additionally be produced with the sequential application of two or more edible binders to a given voxel, or by mixing said edible binders prior to ejection.

The ability to produce a multiplicity of textures within a single 3-D food product, while simultaneously allowing unbound food material to act as a recyclable support for the geometry of said 3-D food product does not exist in the prior art and is therefore an advantage of this system.

### Varying Color Independently

In order to fabricate a food product with uniform coloration, colorant could be added directly to the edible binder(s). In order to produce a complexly and variably colored food product, however, a system for independently varying color is necessary. In accordance with one embodiment, the carriage part 203 may contain plural colorant cartridge parts 205a-d, each of which may contain a different colorant, for example; cyan, magenta, yellow and black. Colorant(s) are ejected from the cartridge parts 205a-d upon selected voxels of a food material layer via the ejector part(s) 204a-d (FIG. 2A-B). This allows for the independent integration of multiple colors within a given 3-D food product.

Intermediate or unique colors or color gradients may additionally be produced with the application of two or more colorants to a given voxel, by mixing said colorants prior to ejection, or through the visual accumulation of differently colored proximal voxels. This capacity to precisely vary color further permits the application of patterns, text, and images to the surface or interior of the food product.

Any colorant utilized should be non-toxic and edible, and should not have deleterious affects on the bound nature of the food material. The pigmentation of a colorant should not deteriorate significantly over time.

No prior art precedent exists for the independent and precise application of color to an edible 3-D food product. This embodiment is capable of producing an edible 3-D food product with independent and complexly varying color, and/or patterns, images and text upon its exterior surface or within its interior that would not be possible using prior art technologies.

### Varying Flavor Independently

Food mixture(s) and edible binder(s) may produce a baseline or ‘background’ flavoring throughout the 3-D food product. To fabricate a food product with additional uniform flavor, the flavor could be added directly to the edible binder (s). However, a complex 3-D food product calls for a multiplicity of flavors and flavor gradients, and therefore necessitates a mechanism for independent variation of flavor.

In accordance with this embodiment, the carriage part 203 may contain multiple flavorant cartridge parts 205h-j, each of which may contain a different flavorant, such as mint, cherry, soy, or more basic flavor tones such as acidity, saltiness, or umami. These flavorants may independently modify or enhance the background flavor of the food product. Flavorant(s) are ejected from the cartridge parts 205h-j upon selected voxels of a food material layer via the ejector part(s) 204h-j (FIG. 2A-B). Intermediate or unique flavors may additionally be produced with the application of two or more flavorants to a given voxel, or by mixing multiple flavorants prior to their application.

The sensations of taste and smell are closely linked during the eating experience, therefore the process of flavor distribution described above may alternately be interpreted as a mechanism of scent distribution.

No prior art precedent exists for the independent variation of flavor or scent within a freeform fabrication product, and is therefore an advantage of this system.

### Advantages Over Prior Art

The embodiment described above is capable of fabricating an edible 3-D food product with intricate and complex geometry and independently variable material composition, texture, color, and flavor/scent. Although the prior art describes many LM processes, none are capable of producing such a product, because they rely upon intrinsically limited extrusion techniques to manipulate semi-solid tubular food materials that are inherently resigned to deformation, because they employ toxic materials and/or thermally extreme processes, or because they lack an adequate mechanism for the independent variation of food characteristics.

Precedents for food extrusion technologies, while successful in the production of an edible food object, are inherently limited in the complexity of geometry they are capable of successfully manufacturing. Because they utilize semi-solid tubular food materials that are fundamentally prone to distortion, delicate and intricate geometries cannot be produced. Extrusion processes additionally waste time and material printing extraneous support material that must later be removed. Further, such technologies offer no adequate mechanism for independently varying food material type, texture, color or flavor within a food product.

Prior art binder deposition LM technologies that are most closely related to this embodiment utilize standard ink-jet cartridges that are produced from toxic materials and contain toxic ink. Such processes would therefore yield an inoperable (inedible, potentially harmful and/or carcinogenic) food product. This embodiment replaces standard toxic inkjet cartridges with food grade inkjet cartridges whose components and materials are entirely non-toxic, such as those available from Edible Supply in Los Angeles, Calif. These food grade cartridges may contain edible binder, edible colorant or edible flavorant. This embodiment thus combines unrelated technologies from the industrial and culinary sectors in order to allow for the production of an edible 3-D food product.

No description of the independent distribution of texture, color and/or flavor within a 3-D food product exists in the prior art. No system capable of producing said independent distribution exists in the prior art. The uncoupling of edible binder, colorant and flavorant variables in accordance with this embodiment allows for the independent application of texture, color and flavor/scent to a 3-D food product. That is, any or all possible iterations of these combined characteristics, or novel mixtures thereof, may exist within a single food product. The independent application of food texture, color, and flavor on a per-voxel basis according to this embodiment allows the 3-D food product designer to conceive of and produce complex food geometries with precisely modulated characteristics not possible under prior art conventions.

### Edible Material Examples Edible Binders:

An edible binder may be any non-toxic, edible liquid or solution that can be ejected by ejector parts and acts to bind a given food material substrate. Edible binders may include, but are not limited to, liquids such as distilled water, milk, fruit or vegetable juices and alcohol, derived from starch products or other products. Edible binders may also comprise a combination of multiple such liquids and/or solutions. Edible binders may additionally contain dissolved edible solids such as salt, sugar, flour or other edible materials.

### Food Materials:

A food material may be any non-toxic, edible material that exhibits appropriate spreading and packing characteristics, and is rendered bound by the addition of one or more edible binders. Food materials that may act as a printing substrate include, but are not limited to, fine or coarse powders derived from sugar, flour, rice, potatoes, corn, cocoa, coffee, baking powder, custard powder, milk powder, powdered egg product, salt, or any other edible material. Particle size and/or particle size variation may be an important consideration in the formulation of a printing substrate. For example, relatively coarse flour particles may be combined with relatively fine flour particles in order to produce a food mixture substance with adequate spreading and packing characteristics. Food materials for use as printing substrates may consist of a single edible ingredient, or a single edible ingredient that has been variably processed to yield particle size variation, or a mixture of multiple edible ingredients.

### Exemplary Recipe:

In order to yield optimal results, food materials and edible binders, such as those suggested above, must operate successfully in concert. Successful food material and edible binder recipes will permit adequate food material binding with minimal shrinkage or expansion of the bound product, adequate bound product strength, and minimal ‘bleeding’ of the edible binder into neighboring voxels. A plethora of variables may further contribute to recipe optimization, including, but not limited to, food material ‘dustiness’, ‘stickiness’, flavor and/or particle size and edible binder viscosity, salinity, alkalinity, acidity and/or alcohol content.

An exemplary recipe according to one embodiment utilized rice wine (86.5% distilled water, 12% alcohol and 1.5% salt) as edible binder, and a food mixture containing 50% granulated sugar, 20% powdered sugar, 20% flour and 10% meringue powder (itself consisting of corn starch, egg whites, sugar, gum arabic, sodium aluminum sulfate, citric acid, cream of tartar and vanillin) as a printing substrate. The edible binder (rice wine) exhibited adequate ejection through standard inkjet cartridges as well as through food grade inkjet cartridges. The food material mixture (powdered and granulated sugar, flour and meringue powder) permitted adequate spreading and packing. Selective application of the edible binder to the food mixture yielded a strongly bound product exhibiting minimal bleeding or other undesirable effects.

### Description and Operation of Alternative Embodiments Combination of Edible Solutions

In accordance with the embodiment discussed above, a carriage part 203 houses separate colorant, edible binder and flavorant cartridge parts 205a-d, 205e-g and 205h-j, respectively, each with corresponding separate ejector parts 204a-d, 204e-g and 204h-j that expel their respective solutions upon the food material layer (FIG. 2A-B). A variety of alternative embodiments entail the removal of one or more of these individual ejector parts in favor of mixing one or more solutions prior to the ejection of the solution mixture from one or more shared ejector part(s).

According to one alternative embodiment, edible solutions (edible binder(s), colorant(s) and flavorant(s)) required for a given voxel are transferred to a mixing area part (not shown), mixed by a mixing part (not shown), and ejected as a mixed solution from one or more shared ejector part(s). For example, edible binder, cyan colorant and mint flavor may be mixed by a mixing part prior to selective ejection upon ‘blue and minty’ voxels of the food material layer, based on per-voxel data.

Similarly, according to another alternative embodiment, if multiple edible binders are required by a given voxel, said edible binders may be transferred to an edible binder mixing area part (not shown), mixed by a mixing part (not shown), and ejected as a mixed edible binder solution from one or more shared edible binder ejector part(s). Likewise, if multiple colorants or flavorants are required by a given voxel, said colorants or flavorants may be transferred to a colorant or flavorant mixing area part (not shown), respectively, mixed by a mixing part (not shown), and ejected as a mixed solution from one or more shared colorant or flavorant ejector part(s).

In accordance with another alternative embodiment, the flavorant cartridge parts 205h-j and flavorant ejector parts 204h-i may be eliminated in favor of incorporating flavorant(s) directly into the edible binder(s), a simplification that may reduce fabrication time and machine complexity. Since edible binder composition may alter the texture of a food product, it may be desirable to maintain a unique edible binder/flavorant solution for each relevant texture/flavor combination in order to maintain the independence of texture and flavor.

Likewise, according to another alternative embodiment, the colorant cartridge parts 205a-d and colorant ejector parts 204a-d may be eliminated in favor of incorporating colorant(s) directly into the edible binder(s), potentially reducing fabrication time and machine complexity. Again, it may be desirable in this case to maintain a unique edible binder/colorant solution for each relevant texture/color combination in order to maintain the independence of texture and color.

Further, according to another alternative embodiment, colorant(s) and flavorant(s) may both be incorporated directly into the edible binder(s), eliminating the cartridge parts 205a-d and 205h-j and ejector parts 204a-d and 204h-j. Again, this simplification may reduce fabrication time and machine complexity, and it may be useful in this case to maintain a unique solution for each texture/flavor/color combination in order to maintain independence of these food characteristics.

Therefore, the capacity for independently varying the texture, flavor, and color of 3-D food products can be accomplished within the framework of a variety of embodiments such as those described above, or within other similar embodiments.

### Combination of Food Materials

Food material composition contributes to the texture and flavor of a food product. In accordance with the embodiments discussed thus far, food materials containing multiple food ingredients are either combined in a manual fashion and deposited into food material storage parts 300a-b prior to food product fabrication, or they are combined in an automated fashion from constituent ingredients residing in food material storage parts 300a-b immediately prior to the deposition of each food material layer (FIG. 5B).

According to an alternative embodiment, one or more food material mixtures required to fabricate a given food product are sequentially prepared in the mixing area part 303 prior to the initiation of the fabrication process, by combining one or more single edible ingredients or food material mixtures from separate food material storage parts 300a-b, as dictated by the computer 100 via the controlling part 101 (FIG. 1). Once prepared, resultant food material mixtures may be stored in a series of surplus food material storage parts and accessed as necessary throughout the fabrication process. For the fabrication of food products comprising multiple food material mixtures, this embodiment may reduce fabrication time.

According to an alternative embodiment, a vibrating part, air moving part, brush part or the like (not shown) may aid in food material mixing or transfer. These parts may also facilitate the purging of the mixing area part 303 and its components before subsequent food materials are mixed.

Therefore, the capacity for efficient production of and access to applicable single food ingredient(s) and/or food material mixture(s) can be accomplished by a variety of embodiments such as those described above, or by other similar embodiments.

According to an additional alternative embodiment, the mixing area part 303, the mixing part 306, the shutting part 304 and the driving parts 307 and 305 are eliminated, as depicted in FIG. 7. This embodiment may be utilized if mixing food materials is not necessary or desirable, or if food material mixtures are produced manually.

### Modification of the Storage, Cartridge and Distributing Parts

FIG. 1 illustrates an embodiment containing two food material storage parts 300a-b. However, according to an alternative embodiment, any number of food material storage parts 300a—may exist.

FIG. 2 illustrates an embodiment containing four colorant cartridge parts 205a-d, three edible binder cartridge parts 205e-g, three flavorant cartridge parts 205h-j, and their associated storage parts 200a-d, 201a-c, 202a-c. However, an alternative embodiment may contain any number of colorant, edible binder and/or flavorant cartridge parts and corresponding storage parts. Further, an alternative embodiment may lack colorant cartridge parts and/or flavorant cartridge parts.

According to an additional alternative embodiment, the distributing part 402 may be a rolling part, a spreading part, a planar member, or another means of distributing food material. The distributing part 402 may be capable of motion or rotation independent of the holding part 401, or it may be stationary or fixed in relation to said holding part. Addition-ally, the distributing part 402 may lack the holding part 401, or may require additional holding parts (not shown). In any of these embodiments, the distributing part 402 may vibrate continuously or differentially in order to facilitate the even and optimal distribution of food material.

### Modification of the Curing Part

In accordance with the embodiment shown in FIG. 1, a curing part 600 is electronically connected to the control-ling part 101. The curing part 600 acts to apply thermal energy to a recently bound cross-sectional body in order to cure said bound region and stabilize the food product as a whole.

In accordance with an alternative embodiment, the curing part is a component of, or is located within the food product containing part 500 such that, as the plate part 503 moves in the Z-direction during the fabrication process, bound layers of the food product are uniformly or differentially cured to maximize food product strength and stability (not shown).

In accordance with an additional alternative embodiment, the curing part is a component of, or is located within the plate part 503.

In accordance with an additional alternative embodiment, the curing part is located in a curing area (not shown).

In accordance with an additional alternative embodiment, the curing part represents a non-thermal means of curing the food product.

### Incorporation of 2-D Representations

In accordance with an alternative embodiment, CAD data or other digital input include information describing one or more two-dimensional entities, in addition to the three-dimensional geometry of the food product. The computer 100 may use software to apply some or all data describing the two-dimensional entity(s) to the distribution of one or more food characteristics upon the surface of, or within the body of the 3-D food product.

For example, input CAD data may describe a photographic image of a man's face, the text “Sam's 50th Birthday”, and a black and white checkerboard pattern. The computer 100 may, in this example, may project the image of the man's face upon the exterior surface of the food product, generating commands for the application of the appropriate colors to the appropriate surface-adjacent voxels. The computer 100 may, similarly, project the input text upon another region of the surface of the food product. It may, further, propagate the checkerboard pattern throughout the interior of the body of the food object, generating commands for the appropriate application of colorant upon interior voxels, as well as potentially for varying flavor within each cube of the (now 3-D) checkerboard pattern. The resultant 3-D food object would feature the image of a man's face on one side of its exterior, the text “Sam's 50th Birthday” on the other side, and exhibit a 3-D checkerboard consisting of alternating white, vanilla-flavored and black, chocolate-flavored cubes throughout its interior.

### CONCLUSION, RAMIFICATIONS, AND SCOPE

Thus, the reader will see that prior art does not describe a freeform fabrication system capable of the production of an edible food product with complex and intricate geometry. Prior art is either fundamentally incompatible with the production of food, or is imprecise, requires the fabrication of support structure that wastes time and material, and relies upon semi-solid material that is inherently prone to deformation. There is no precedent for the independent modulation of texture, flavor and color in the fabrication of a 3-D food product, although these characteristics are important to the experience of the consumer. At least one embodiment of the freeform fabrication system described in this application remedies these prior failings, producing an entirely edible food product with complex and delicate geometry and independently varying color, flavor, and texture.

While the descriptions above contain many specificities, these should not be construed as limitations on the scope of this application, but rather as providing illustrations of some of the presently preferred embodiments. Many other variations, shapes, scales and materials are possible. For example, the system may constitute a means for fabricating food products in a high-throughput manner, the system may produce large-scale or miniature food products, the system may produce food products with food characteristics not expressly discussed above or not in existence at the time of this application.

Accordingly, the scope of the embodiment should be determined by the appended claims and their legal equivalents, rather than by the embodiment(s) illustrated and discussed.

### ABSTRACT

A freeform fabrication system for the production of an edible three-dimensional food product from digital input data is disclosed. Food products are produced in a layer-by-layer manner without object-specific tooling or human intervention. Color, flavor, texture and/or other characteristics may be independently modulated throughout the food product.

We claim:

1-20. (canceled)

21. A method for making an edible component, comprising
depositing successive layers of an unbound powder food material according to digital data that describes the edible component; and
applying to one or more regions of each of the successive layers of food material one or more edible binders that bond the food material at said one or more regions to form said edible component,
wherein the digital data describes sequential cross-sectional layers of the edible component, the cross-sectional layers comprising a plurality of voxels, and
wherein proximal voxels of the plurality of voxels vary in food material composition, color, flavor, or a combination thereof.

22. The method of claim 21, wherein the sequential cross-sectional layers are generated from CAD data.

23. The method of claim 21 further comprising applying to one or more of the regions of one or more of the successive layers of food material one or more additional edible solutions.

24. The method of claim 23, wherein the one or more additional edible solutions and the one or more edible binders are applied to the food material simultaneously.

25. The method of claim 23, wherein the one or more additional edible solutions and the one or more edible binders are applied to the food material sequentially.

26. The method of claim 23, wherein two or more of the additional edible solutions are combined with one another prior to their application to the food material.

27. The method of claim 26, wherein the two or more additional edible solutions are manually combined with one another.

28. The method of claim 21, wherein the food material of one or more of the successive layers differs compositionally from the food material of a neighboring layer.

29. The method of claim 21, wherein the food material of one or more of the successive layers comprises a mixture of more than one ingredient.

30. The method of claim 29, wherein the ingredients of the mixture are combined prior to depositing the food material.

31. The method of claim 21, wherein the food material comprises sugar, flour, rice, potato, corn, cocoa, coffee, baking powder, custard powder, meringue powder, milk powder, powdered egg product, salt, wasabi, starch, gum arabic, cream of tartar, vanillin, or a mixture thereof.

32. The method of claim 21, wherein the one or more edible binders comprises distilled water, milk, fruit juice, vegetable juice, alcohol, rice wine, a starch product, or a mixture thereof.

33. The method of claim 21, wherein the one or more edible binders comprises a dissolved edible solid.

34. The method of claim 23, wherein the one or more additional edible solutions comprises a colorant, a flavorant, or a mixture thereof.

35. The method of claim 34, wherein different additional edible solutions are applied to different voxels of a layer of food material.

36. The method of claim 21, wherein surrounding unbound powder food material supports the edible component during formation of the edible component.
